(19) United States
(12) Patent Application Publication
(10) Pub. No.: US 2025/0020978 A1
(43) Pub. Date: Jan. 16, 2025

(54) CONTROL METHOD, LENS CONTROL DEVICE, LENS DRIVER, AND FOLLOW FOCUS CONTROL SYSTEM

(71) Applicant: Shenzhen Leqi Innovation Co., Ltd., Shenzhen (CN)

(72) Inventors: Feng ZHOU, Shenzhen (CN); Wei TANG, Shenzhen (CN); Peiwen HE, Shenzhen (CN); Zefeng MA, Shenzhen (CN); Jinxu LAI, Shenzhen (CN); Zishuai HU, Shenzhen (CN)

(73) Assignee: Shenzhen Leqi Innovation Co., Ltd., Shenzhen (CN)

(21) Appl. No.: 18/900,978

(22) Filed: Sep. 30, 2024

Related U.S. Application Data
(63) Continuation of application No. PCT/CN2023/112824, filed on Aug. 14, 2023.

(30) Foreign Application Priority Data
Sep. 2, 2022 (CN) 202211070567.7

(51) Int. Cl. G03B 13/36; G03B 3/12

(52) U.S. Cl. CPC G03B 13/36; G03B 3/12

(57) ABSTRACT

The present invention discloses a lens control device and a control method thereof, a lens driver and a control method thereof, and a follow focus control system. The lens control device includes adjusting members. The control method of the lens control device includes: upon detecting a change of position data of any one adjusting member, acquiring current position data of the adjusting member and a matching identification corresponding to the adjusting member; and generating and wirelessly transmitting an adjustment signal based on the acquired position data and the matching identification, the adjustment signal containing the matching identification, the matching identification being provided for a lens driver that receives the adjustment signal to perform a match verification. The technical solution of the present invention effectively prevents the communication signals between the lens control device and the lens driver from being interfered with and improving control accuracy of the lens.

### TECHNICAL FIELD

The present invention relates to the technical field of photographic auxiliary equipment, and more particularly to a control method applied to a lens control device, a control method applied to a lens driver, a lens control device, a lens driver, and a follow focus control system.

### BACKGROUND OF THE ART

During a course of photographing, photographic equipment (such as equipment including video cameras or cameras) needs to adjust the focus and focal length of the lens in a timely manner to adapt to the composition of an image. During the course of photographing, the photographic equipment usually needs to move according to the needs of a photographed image, and most photographic equipment is usually very heavy, so that it is difficult to manually rotate the lens to zoom during the course of photographing. Currently, a commonly adopted solution is to install a lens driver beside to the lens for driving a lens focus ring to rotate, and to achieve zooming and focusing by adjusting a lens control device (a follow focus controller) that is in wired or wirelessly connection with the lens driver.

Since the zooming adjustment and focusing adjustment of the lens of photographic equipment require driving performed by a lens driver, and some photographic equipment also needs a lens driver to adjust the filter transmittance of the lens, it is usually necessary to install at least two lens drivers on the photographic equipment. At present, multiple lens control devices are usually configured to separately control each of the lens drivers. Each of the lens control devices communicates with the corresponding lens driver on the same channel, and each of the lens control devices uses a different channel. Due to the limited number of channels, in the communication channel between a lens control device and a lens driver, there will be communication signals from other equipment, easily causing interference with the communication between the lens control device and the lens driver, and affecting the precise control of the lens.

### SUMMARY OF THE INVENTION

There is a desire to provide an improved control method, an improved lens control device, an improved lens driver, and an improved follow focus control system to prevent the communication signal between the lens control device and the lens driver from being interfered with and improve control accuracy of the lens.

In one aspect, the present invention provides a control method, applicable to a lens control device which comprises at least one adjusting member, the control method comprising:
upon detecting a change of position data of one of the at least one adjusting member, acquiring a current position data of said one of the at least one adjusting member and a matching identification corresponding to said one of the at least one adjusting member; and
generating and wirelessly transmitted an adjustment signal based on the current position data and the matching identification, wherein the adjustment signal contains the matching identification which is provided for a lens driver that receives the adjustment signal to perform a match verification.

In some embodiments, the adjusting member is a rotating member, and the position data comprises an angular position.

In some embodiments, the lens control device comprises a digital signal port for wired connection to the lens driver, and after generating the adjustment signal the control method further comprises:
upon detecting the digital signal port being connected to the lens driver, switching to a wired signal transmission mode to perform signal transmission via the digital signal port; and
upon detecting the digital signal port not being connected to the lens driver, switching to a wireless signal transmission mode.

In some embodiments, the lens control device comprises a main body which is provided with one of the at least one of the adjusting member and at least one port for connecting with an external accessory including another adjusting member; and the control method further comprises:
upon detecting the main body connecting with the accessory, acquiring position data and a corresponding matching identification of the another adjusting member of the accessory; and
generating and wirelessly transmitting another adjustment signal based on the position data and the corresponding matching identification of the another adjusting member of the accessory, wherein the another adjustment signal contains the corresponding matching identification of the another adjusting member of the accessory which is provided for being received by the lens driver that receives the another adjustment signal to perform another match verification.

In some embodiments, the lens control device further comprises a display screen, and the control method further comprises:

controlling the display screen to display data information of the at least one adjusting member, the data information at least including the position data.

In some embodiments, the lens control device comprises a main body, the main body being provided with one of at least one of the adjusting member and at least one port for connecting with an external accessory including another adjusting member; and the control method further comprises:
upon detecting the main body connecting with an accessory, adding a display zone on the display screen and displaying data information of the another adjusting member of the accessory in the display zone; and
upon detecting the main body disconnecting from the accessory, canceling the display zone from the display screen.

In some embodiments, the control method further comprises:
upon receiving a reminder signal transmitted from the lens driver, executing corresponding reminder processing according to the reminder signal.

In some embodiments, the lens control device further comprises a pushbutton device, and the control method further comprises a step of:

upon detecting a pushbutton signal of the pushbutton device, executing corresponding processing based on the pushbutton signal.

In some embodiments, the step of upon detecting a pushbutton signal of the pushbutton device, executing corresponding processing based on the pushbutton signal comprises:

upon detecting a channel switching signal, switching a current communication channel.

In some embodiments, the step of upon detecting a pushbutton signal of the pushbutton device, executing corresponding processing based on the upon detecting a first dot-mark setting signal, entering a dot-mark setting mode;

upon detecting a switching signal, switching a currently selected adjusting member in response to the switching signal;

upon detecting a second dot-mark setting signal, identifying mark A of the currently selected adjusting member;

upon detecting a third dot-mark setting signal, identifying mark B of the currently selected adjusting member; and

upon detecting a return signal, exiting the dot-mark setting mode.

In some embodiments, the step of upon detecting a pushbutton signal of the pushbutton device, executing corresponding processing based on the pushbutton signal comprises:
upon detecting a first dot-mark cancelling signal, entering a dot-mark cancelling mode;
upon detecting a switching signal, switching a currently selected adjusting member;
upon detecting a second dot-mark cancelling signal, cancelling mark A and mark B of the currently selected adjusting member; and
upon detecting a return signal, exiting the dot-mark cancelling mode.

In some embodiments, the step of upon detecting a pushbutton signal of the pushbutton device, executing corresponding processing based on the pushbutton signal comprises:
upon detecting an identification setting signal, entering an identification setting mode;
upon detecting a switching signal, switching a currently selected adjusting member;
upon detecting an up scrolling signal, up scrolling to switch the matching identification of the currently selected adjusting member;
upon detecting a down scrolling signal, down scrolling to switch the matching identification of the currently selected adjusting member; and
upon detecting a return signal, exiting the identification setting mode.

In some embodiments, the step of upon detecting a pushbutton signal of the pushbutton device, executing corresponding processing based on the upon detecting a stroke calibration signal, entering a stroke calibration mode;

upon detecting a switching signal, switching a currently selected adjusting member;

upon detecting a calibration confirmation signal, wirelessly transmitting a calibration instruction, wherein the calibration instruction contains the matching identification of the currently selected adjusting member; and

upon receiving a calibration completion signal or a calibration failure signal transmitted from the lens driver, or upon detecting a return signal, exiting the stroke calibration mode.

In some embodiments, the step of upon detecting a pushbutton signal of the pushbutton device, executing corresponding processing based on the pushbutton signal comprises:
upon detecting a locking signal, entering a pushbutton locking mode;
and

upon detecting an unlocking signal, exiting the pushbutton locking mode;

and/or

upon detecting a start recording signal, wirelessly transmitting a start recording instruction; and

upon detecting a stop recording signal, wirelessly transmitting a stop recording instruction.

In another aspect, the present invention provides a control method, applicable to a lens driver which comprises a drive mechanism for driving a lens, the control method comprising:
upon receiving an adjustment signal wirelessly transmitted from a lens control device, performing a match verification between an identification of the adjustment signal and a preset equipment identification; and
when the matching verification is passed, controlling the drive mechanism to move based on the adjustment signal.

In some embodiments, the control method further comprises:

upon detecting a preset type of event, wirelessly transmitting a corresponding reminder signal to the lens control device, wherein the reminder signal contains a preset equipment identification.

In some embodiments, the lens driver comprises a signal port for connecting with photographic equipment, and the control method further comprises:
upon receiving a start recording signal transmitted from the lens control device, outputting an activation instruction from the signal port; and
upon receiving a stop recording signal transmitted from the lens control device, outputting a deactivation instruction from the signal port.

In some embodiments, the lens driver further comprises a pushbutton unit, and the control method further comprises:
upon detecting a channel switching signal generated by the pushbutton unit, switching a current communication channel; and/or
upon detecting an equipment identification switching signal generated by the pushbutton unit, switching the equipment identification.

In a further another aspect, the present invention provides a lens control device, comprising at least one adjusting member, a storage device, a processor, and a control program stored in the storage device and executable in the processor, the control program implementing steps of the control method according to claim 1 when executed in the processor.

In a still another aspect, the present invention provides a lens driver, comprising a drive mechanism, a storage device, a processor, and a control program stored in the storage device and executable in the processor, the control program implementing steps of the control method according to claim 15 when executed in the processor.

In a still further another aspect, the present invention provides a follow focus control system, comprising the lens control device described above and at least one lens driver described above.

In some embodiments, the follow focus control system further comprises multiple lens drivers, wherein when the equipment identifications of the multiple lens drivers are identical, one adjustment signal of the lens control device controls the multiple lens drivers to drive synchronously.

In the technical solution of a control method according to the present invention, when a change of position data of any adjusting member (that is a user adjusts said any adjusting member) is detected, a current position data of the adjusting member and a corresponding matching identification are acquired in order to generate an adjustment signal containing the matching identification to be transmitted wirelessly. Since the wirelessly transmitted the adjustment signal contains the matching identification corresponding to the adjusting member, the lens driver, upon receiving the adjustment signal, must first verify the matching identification contained in the adjustment signal, and executes corresponding driving adjustment according to the adjustment signal only after the matching identification passes verification. As such, even there is a signal from other wireless equipment in the communication channel between the lens control device and the lens driver, the lens driver will not mistakenly execute the wireless signal transmitted from other equipment, effectively preventing the communication signal between the lens control device and the lens driver from being interfered with and improving control accuracy of the lens.

### BRIEF DESCRIPTION OF THE DRAWINGS

FIG. 1 is a schematic view illustrating a flow of a control method according to one embodiment of the present invention;

FIG. 2 is a schematic view illustrating a flow of a control method according to one embodiment of the present invention;

FIG. 3 is a schematic view illustrating a flow of a control method according to one embodiment of the present invention;

FIG. 4 is a schematic view illustrating a flow of a control method according to one embodiment of the present invention;

FIG. 5 is a schematic view illustrating a flow of a control method according to one embodiment of the present invention;

FIG. 6 is a schematic view illustrating a flow of a control method according to one embodiment of the present invention;

FIG. 7 is a schematic view illustrating a flow of a control method according to one embodiment of the present invention;

FIG. 8 is a schematic view illustrating a flow of a control method according to one embodiment of the present invention;

FIG. 9 is a schematic view illustrating a flow of a control method according to one embodiment of the present invention;

FIG. 10 is a schematic view showing a structure of electronic equipment of a hardware operation environment related to a solution of an embodiment of the present invention.

FIG. 11 illustrates a lens control device wireless connected with a lens driver according to one embodiment of the present invention; and

FIG. 12 illustrates a lens control device wireless connected with a lens driver according to an alternative embodiment of the present invention.

### DETAILED DESCRIPTION OF THE PREFERRED EMBODIMENTS

The technical solutions of embodiments of the present invention will be clearly and completely described below with reference to the accompanying drawings of the embodiments of the present invention. Obviously, the described embodiments are only some, but not all, of the embodiments of the present invention. Based on the embodiments of the present invention, those having ordinary skill of the technical field may contemplate, without making creative efforts, other embodiments that all fall within the scope of protection of the present invention.

The present invention provides a control method, which is applicable to a lens control device of photographic equipment, and the lens control device comprises at least one adjusting member.

The photographic equipment can be for example a video camera and a camera. The lens control device is configured to control operation of a lens driver of the photographic equipment, and the lens driver is configured to drive a zoom ring, a focus ring, or a filter adjustment wheel of a lens of the photographic equipment in order to carry out zooming adjustment, focusing adjustment, or light transmittance adjustment on the lens. The adjusting member is a moving member of the lens control device, and the adjusting member can be a rotating member rotatably arranged on the lens control device, such as rotary knob, a rotary wheel, a rotating shaft, or a rotating disk, and the adjusting member can alternatively be a sliding member slidably arranged on the lens control device, such as slide block.

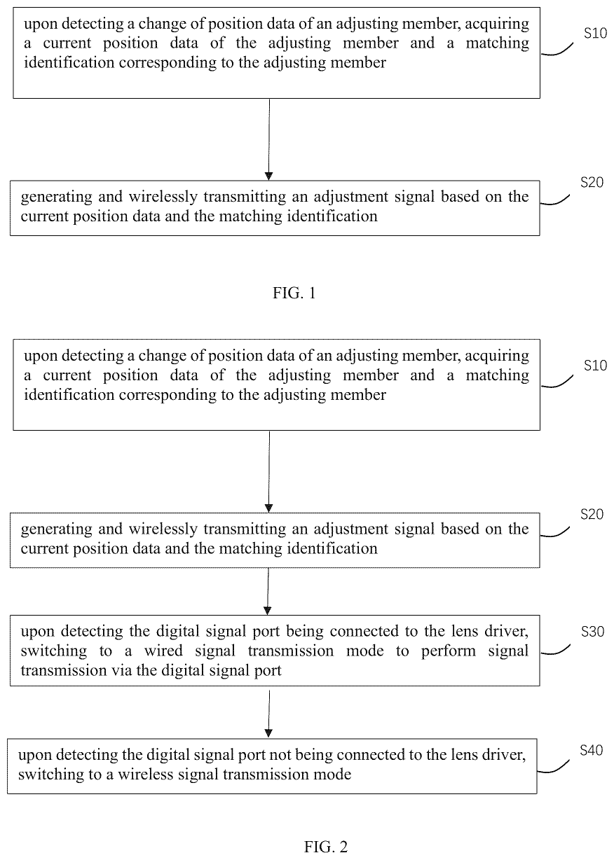

Referring to FIG. 1 which is a schematic view illustrating a flow of a control method according to one embodiment of the present invention.

In the instant embodiment, the control method comprises:

Step S10, upon detecting a change of position data of one adjusting member, acquiring a current position data of the adjusting member and a matching identification corresponding to the adjusting member.

In the instant embodiment, an implementation terminal can be a controller of the lens control device. The controller stores the matching identification corresponding to each adjusting member. The matching identification can be numbers such as 01, 02, and 03, and letters such as A, B, and C, and various types of identifications such as character strings. The lens control device comprises a detection device (such as a transducer device), which is configured to detect the position data of the adjusting member. The detection device feeds the position data detected thereby back to the controller. When a user operates the adjusting member to move (rotating or sliding), the controller determines the position data of the adjusting member changes based on the position data fed back by the detection device (for example comparing the position data received at the current time and the position data received in a previous time). At this time, the controller acquires the current position data of the one adjusting member that the user rotates or slides, and also acquires the matching identification corresponding to the adjusting member. If the adjusting member is a rotating member, the position data is an angular position; and if the adjusting member is a sliding member, the position data is a displacement amount which represents how much the sliding member has slide from a starting point. In the embodiments of the present invention descried below, the adjusting member being a rotating member and the position data being an angular position is taken as an example for illustrating the present invention.

Step S20, generating and wirelessly transmitting an adjustment signal based on the acquired position data and the matching identification.

After acquiring the current position data of the adjusting member and the corresponding matching identification, the controller carries out preset signal conversion processing based on the acquired position data and the matching identification in order to generate a corresponding adjustment signal containing the matching identification and transmit the adjustment signal in a wireless manner. The adjustment signal contains the matching identification which is configured for a lens driver that receives the adjustment signal to carry out matching verification. After the adjustment signal is wirelessly transmitted, each lens driver in wireless connection with the lens control device may receive the adjustment signal, and after receiving the adjustment signal, the lens driver needs to first verify the matching identification of the adjustment signal, and carries out a corresponding driving operation based on the adjustment signal only after the verification is passed, meaning the adjustment signal is only executable by the lens driver corresponding to the adjusting member operated by the user. It is noted that the adjusting members of the lens control device can be corresponding one by one to the lens drivers, meaning each adjusting member controls and adjusts the corresponding lens driver, and alternatively, the adjusting members of the lens control device may correspond to multiple lens drivers, meaning one adjusting member simultaneously controls multiple lens drivers.

In the control method of the lens control device of the instant embodiment, when a change of the position data of any one of the adjusting members is detected (that is when the user adjusts said any one of the adjusting members), the current position data of the adjusting member and the matching identification corresponding thereto are acquired in order to generate the adjustment signal containing the matching identification to be wirelessly transmitted. Since the wirelessly transmitted adjustment signal includes the matching identification corresponding to the adjusting member, the lens driver, upon receiving the adjustment signal, has to first verify the matching identification of the adjustment signal and to carry out corresponding driving adjustment based on the adjustment signal only after the matching identification passes the verification. As such, even there is a signal from other wireless equipment in the communication channel between the lens control device and the lens driver, the lens driver will not mistakenly execute the wireless signal transmitted from other equipment, effectively preventing the communication signal between the lens control device and the lens driver from being interfered with and improving control accuracy of the lens.

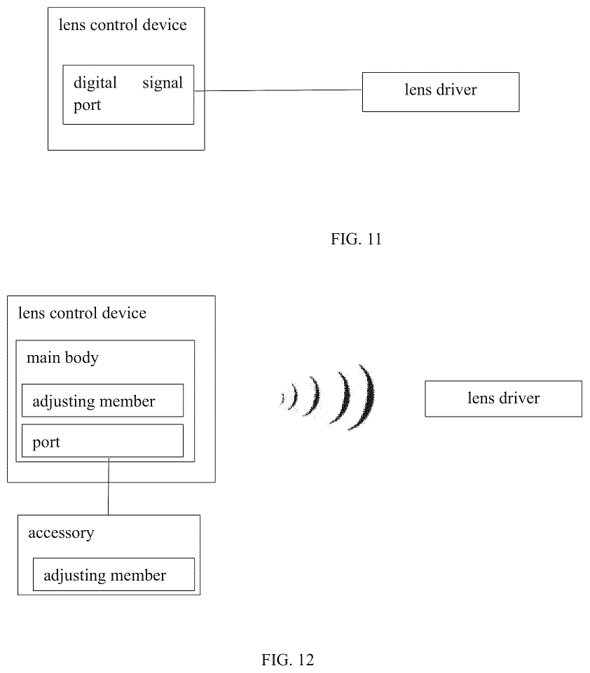

Referring to FIG. 2 and FIG. 11, in the instant embodiment, the lens control device comprises a digital signal port (such as Type-C port) for wired connection with the lens driver. The digital signal port may be in wired connection with the lens driver through a signal line. The control method of the instant embodiment further comprises:

Step S30, upon detecting the digital signal port being wired connection with the lens driver, switching to a wired signal transmission mode and performing signal transmission thought the digital signal port; and

Step S40, upon detecting the digital signal port being not wired connection with the lens driver, switching to a wireless signal transmission mode.

In the instant embodiment, the lens control device has both wired transmission and wireless transmission modes. When the lens control device is in the wired signal transmission mode, output of the adjustment signal is performed through the digital signal port; and when the lens control device is in the wireless signal transmission mode, output of the adjustment signal is made in a wireless manner. Optionally, the digital signal port feeds back one signal to the controller when connected with the lens driver and feeds back another signal to the controller when not connected with the lens driver, so that the controller may determine whether or not the digital signal port is connected to the lens driver based on the signal fed back by the digital signal port to thereby switch to a corresponding signal output mode. Of course, the controller can also adopt other measures to detect and determine whether or not the digital signal port is connected with the lens driver. The control method of the instant embodiment automatically switches to a corresponding signal transmission mode based on whether the digital signal port is wired connection with the lens driver or not, so that the lens control device can be intelligently switched between the wireless transmission mode and the wired transmission mode.

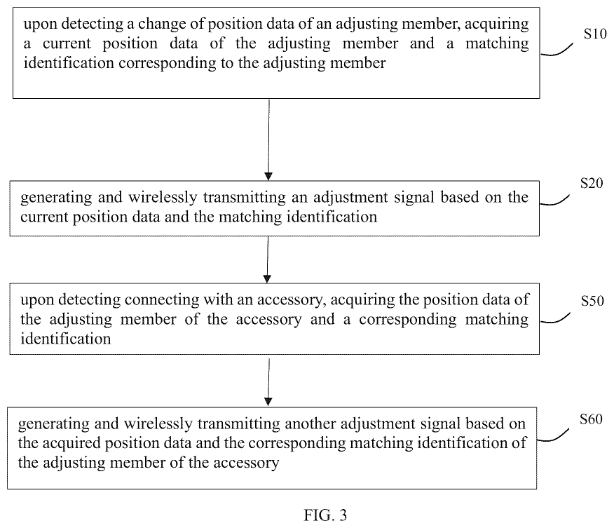

Referring to FIG. 3 and FIG. 12, in the instant embodiment, the lens control device comprises a main body, and the main body is provided with at least one adjusting member and at least one port for externally connecting with an accessory including another adjusting member. The control method of the instant embodiment further comprises:

Step S50, upon detecting the main body connecting with the accessory, acquiring the position data of the another adjusting member of the accessory and a corresponding matching identification; and

Step S60, generating and wirelessly transmitting another adjustment signal based on the acquired position data and matching identification of the accessory.

When the user mounts a new accessory to the port of the main body, the controller, upon detecting the connection of the new accessory to the main body, acquires the position data of the adjusting member of the newly connected accessory and a corresponding matching identification. The controller may store therein the matching identification of each port, and the matching identification of the newly connected accessory can be the matching identification corresponding to the port to which the new accessory is mounted. After the position data of the newly connected adjusting member and the matching identification are acquired, based on the acquired position data and the matching identification, another adjustment signal containing the matching identification of the accessory is generated and transmitted wirelessly, so that the lens driver corresponding to the newly connected adjusting member can be adjusted to be synchronized with the adjusting member.

The control method of the instant embodiment, upon detecting the connection of the accessory, immediately acquires the position data and the matching identification of the adjusting member of the accessory and generates a corresponding adjustment signal to be transmitted wirelessly, so that the lens driver corresponding to the adjusting member of the accessory can quickly complete synchronization therewith.

In some embodiments, the lens control device further comprises a display screen, and the control method further comprises: controlling the display screen to display data information of each adjusting member. Displaying the data information of each adjusting member through the display screen allows the user to intuitively know a status of the lens control device based on the display screen. In this, the data information at least includes the position data of the adjusting member, and the data information may also include data information such as channel data, matching identification, and power level.

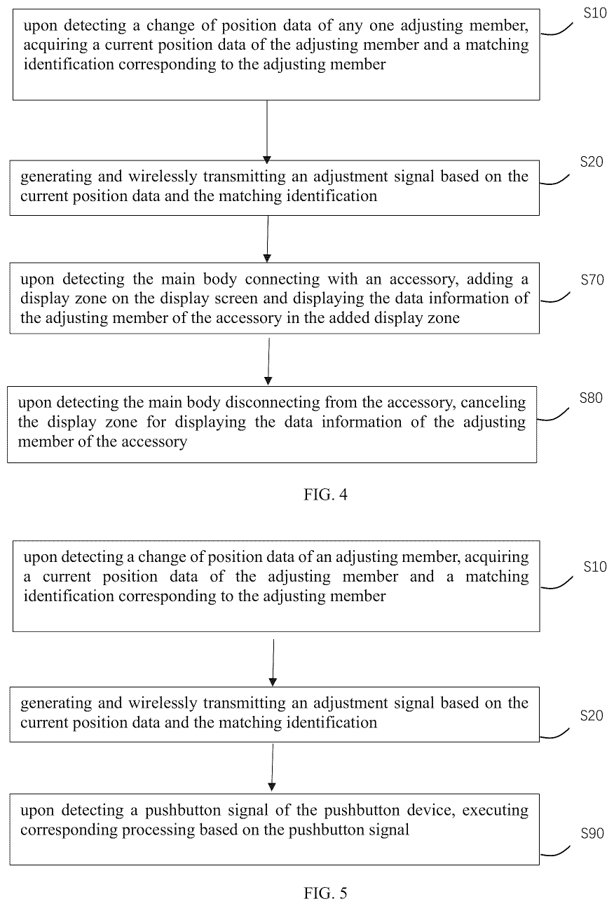

In the instant embodiment, the lens control device comprises a main body, and the main body is provided with at least one adjusting member and at least one port for externally connecting with an accessory including an adjusting member. Referring to FIG. 4, the control method of the instant embodiment further comprises:

Step S70, upon detecting the main body connecting with an accessory, adding a display zone on the display screen and displaying the data information of the adjusting member of the accessory in the added display zone; and

Step S80, upon detecting the main body disconnecting from the accessory, canceling the display zone for displaying the data information of the adjusting member of the accessory.

Each time an accessory is connected to the lens control device, the display screen is controlled to add a new display zone, so that the data information of each adjusting member is displayed in a separate zone, and each adjusting member corresponds to one display zone. For example, when the main body of the lens control device is not connected to an accessory, the data display zone of the display screen is a single zone, which displays the data information of the adjusting member of the main body; when the main body is connected with one accessory, the data display zone of the display screen is divided into two zones, and when the main body is connected with two accessories, the data display zone of the display screen is divided into three zones, and each zone displays the data information of the corresponding adjusting member.

By detecting the connection or disconnection of an accessory, the control method of the instant embodiment automatically switches the display mode of the display screen, so that the data information of each adjusting member is displayed in a separate zone on the display screen, allowing the user to more clearly known the data information of each adjusting member.

In some embodiments, the control method of the lens control device further comprises: upon receiving a reminder signal transmitting from the lens driver, executing corresponding reminder processing according to the reminder signal.

In some embodiments, the reminder signal may include a low power level reminder signal and a locking reminder signal. When the reminder signal from the lens driver is received, the corresponding reminder processing executed by the controller based on the reminder signal may be: controlling the display screen to display a corresponding reminder interface or controlling the lens driver device to vibrate or controlling an indicator light to flash in a preset manner.

Referring to FIG. 5, in the instant embodiment, the lens control device further comprises a pushbutton device, and the control method of the instant embodiment further comprises:

Step S90, upon detecting a pushbutton signal of the pushbutton device, executing corresponding processing based on the pushbutton signal.

The pushbutton device comprises at least one pushbutton. The pushbutton device is used for the user to operate to generate a corresponding pushbutton signal to the controller, and the controller executes processing corresponding to the pushbutton signal based on the detected pushbutton signal so as to realize the user controlling, adjusting, or setting the lens control device through the pushbutton device. The way of generating the pushbutton signal can be that the generation is made by means of single click of a specific pushbutton or the generation is made by double click of a specific pushbutton, or the generation is made by pressing down multiple pushbuttons, or by pressing a specific pushbutton to reach a specific interval of time.

In some embodiments, Step S90 includes: upon detecting a channel switching signal, switching a current communication channel.

In the instant embodiment, the pushbutton signal of the pushbutton device includes a channel switching signal, and upon detecting the channel switching signal generated by the pushbutton device, the controller switches the current communication channel according to a preset manner. The preset manner can be a random manner or a sequentially increasing or decreasing manner. For example, the channel switching signal includes a channel plus 1 signal, a channel minus 1 signal. If a channel plus 1 signal is detected, the communication channel is switched by plus 1; if a channel minus 1 signal is detected, and the communication channel is switched by minus 1. In the instant embodiment, the communication channel may include 16 channels of F00-F15. The instant embodiment fulfills a channel switching function through the pushbutton module, and any channel can be selected for communication according to the needs.

In some embodiments, Step S90 comprises:
upon detecting a dot-mark setting signal, entering a dot-mark setting mode; and
in the dot-mark setting mode:
upon detecting a switching signal, switching a currently selected adjusting member;
upon detecting the dot-mark setting signal, identifying mark A of the currently selected adjusting member;
upon detecting the dot-mark setting signal, identifying mark B of the currently selected adjusting member; and
upon detecting a return signal, exiting the dot-mark setting mode.

For example, the pushbutton device comprises a dot-mark pushbutton and a setting pushbutton. In a standby mode (that is a main interface mode), single click of the dot-mark pushbutton generates the dot-mark setting signal; and in the dot-mark setting mode, single click of the setting pushbutton generates the switching signal, and long pressing of the setting pushbutton, or no operation carried out in a predetermined period of time (such as 10 seconds), generates the return signal.

The control method of the instant embodiment fulfills a dot-mark setting function of the lens control device.

In some embodiments, Step S90 comprises:
upon detecting a dot-mark cancelling signal, entering a dot-mark cancelling mode; and
in the dot-mark cancelling mode:
upon detecting a switching signal, switching a currently selected adjusting member;
upon detecting the dot-mark cancelling signal, cancelling mark A and mark B of the currently selected adjusting member; and
upon detecting a return signal, exiting the dot-mark cancelling mode.

For example, the pushbutton device comprises a cancel pushbutton and a setting pushbutton. In a standby mode, single click of the cancel pushbutton generates the dot-mark cancelling signal; and in the dot-mark cancelling mode, single click of the setting pushbutton generates the switching signal, and long pressing of the setting pushbutton, or no operation carried out in a predetermined period of time (such as 10 seconds), generates the return signal.

The control method of the instant embodiment enables the lens control device to fulfill a dot-mark cancelling function.

In some embodiments, Step S90 comprises:
upon detecting an identification setting signal, entering an identification setting mode; and
in the identification setting mode:
upon detecting a switching signal, switching a currently selected adjusting member;
upon detecting an up scrolling signal, up scrolling to switch the matching identification of the currently selected adjusting member;
upon detecting a down scrolling signal, down scrolling to switch the matching identification of the currently selected adjusting member; and
upon detecting a return signal, exiting the identification setting mod.

For example, the pushbutton device comprises a setting pushbutton, an up pushbutton, and a down pushbutton, and in a standby mode, single click of the setting pushbutton generates the identification setting signal; and in the identification setting mode, single click of the setting pushbutton generates a switching signal, and single click of the up pushbutton generates the up scrolling signal, and single click of the down pushbutton generates the down scrolling signal, and long pressing of the setting pushbutton, or no operation being carried out in a predetermined period of time (such as 10 seconds), generates the return signal. For example, the matching identification can be switched among 01-03, and one up scrolling signal makes up switching one time (such as switching from 01 to 02, switching from 02 to 03, and switching from 03 to 01), and one down scrolling signal makes down switching one time (such as switching from 03 to 02, switching from 02 to 01, and switching from 01 to 03).

The control method of the instant embodiment enables the lens control device to fulfill the identification setting function for the adjusting member, allowing the user to modify and set the lens driver to which each adjusting member corresponds by himself or herself, making it convenient for the user to set according to needs.

In some embodiments, Step S90 comprises:
upon detecting a stroke calibration signal, entering a stroke calibration mode; and
in the stroke calibration mode:
upon detecting a switching signal, switching the currently selected adjusting member;
upon detecting a calibration confirmation signal, wirelessly transmitting a calibration instruction, wherein the calibration instruction contains the matching identification of the currently selected adjusting member; the lens driver, upon receiving the calibration instruction, first verifies the matching identification of the calibration instruction, and executes stroke calibration after the verification is passed; upon completing the stroke calibration, the lens driver wirelessly transmits a calibration completion signal, and in case of failure of the stroke calibration, wirelessly transmits a calibration failure signal.

When the calibration completion signal/the calibration failure signal transmitting from the lens driver is received, or when a return signal is detected, exit from the stroke calibration mode.

For example, the pushbutton device comprises a dot-mark pushbutton, a setting pushbutton, an up pushbutton, and a down pushbutton. In the standby mode, long pressing of the dot-mark pushbutton generates the stroke calibration signal; in the stroke calibration mode, single click of the up pushbutton or the down pushbutton generates the switching signal, and single click of the dot-mark pushbutton generates the calibration confirmation signal, and long pressing of the setting pushbutton generates the return signal.

The control method of the instant embodiment enables the lens control device to fulfill a function of controlling the lens driver to automatically execute stroke calibration.

In some embodiments, Step S90 comprises:
upon detecting a locking signal, entering a pushbutton locking mode; and
in the pushbutton locking mode, upon detecting an unlocking signal, exiting the pushbutton locking mode.

For example, the pushbutton device comprises a locking button, and double click of the locking button generates the locking signal; and in the pushbutton locking mode, double click of the locking button generates the unlocking signal.

The control method of the instant embodiment enables the lens control device to fulfill a pushbutton locking function, preventing a situation that a pushbutton is accidentally triggered during use.

In some embodiments, Step S90 comprises:
upon detecting a start recording signal, wirelessly transmitting a start recording instruction; and
upon detecting a stop recording signal, wirelessly transmitting a stop recording instruction.

For example, the pushbutton device comprises a recording button, and single click of the recording button generates the start recording signal/the stop recording signal. The start recording instruction and the stop recording instruction can be received by the lens driver and can also be received by the photographic equipment (camera). The lens driver, upon receiving the start recording instruction, transmits an activation instruction through a data line connected to the photographic equipment to the photographing equipment to control the photographing equipment to activate recording, and the lens driver, upon receiving the stop recording instruction, transmits a deactivation instruction through the data line connected to the photographic equipment to the photographing equipment to control the photographing equipment to deactivate recording.

The control method of the instant embodiment enables the lens control device to fulfill a function of wirelessly controlling recording by photographing equipment, facilitating remote control of the photographing equipment to carry out recording.

It is noted that in all of the above-described embodiments, the various signals wirelessly transmitted from the lens driver may include the equipment identification of the lens driver, and the equipment identification is provided for the lens control device to verify and identify the wirelessly received signals in order to identify and determine the lens driver from which the signals come.

The present invention also provides a control method, which is applicable to a lens driver which comprises a drive mechanism for driving a lens, wherein the drive mechanism may comprise a gear and a motor that drives the gear to rotate, and the gear is configured to mesh with a zoom ring, a focus ring, or a filter adjustment wheel of the lens.

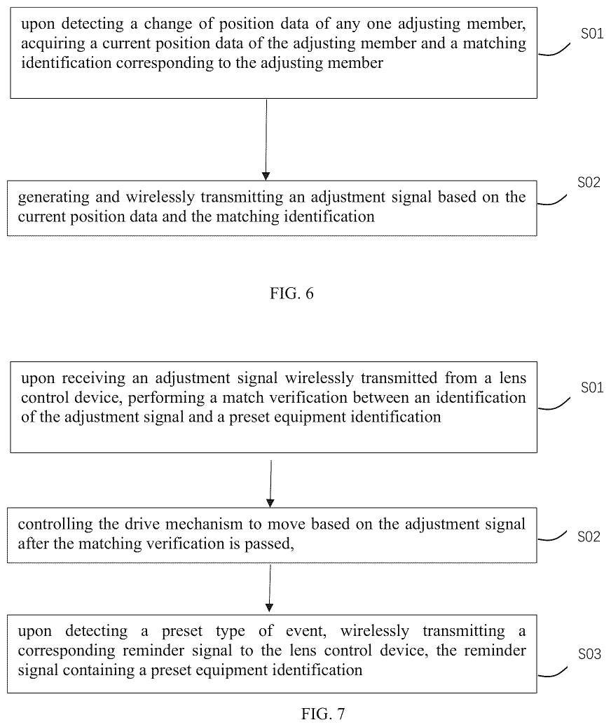

Referring to FIG. 6, the control method according to the present invention comprises:

Step S01, upon receiving an adjustment signal wirelessly transmitted from a lens control device, performing a match verification between an identification of the adjustment signal and a preset equipment identification.

An implementation terminal of the control method according to the instant embodiment can be a controller of the lens driver. The controller stores a preset equipment identification. The equipment identification can be numbers (such as 01, 02, and 03) and can also be letters (such as A, B, and C), and can also be various types of identifications such as character strings. After receiving the adjustment signal wirelessly transmitted from the lens control device, the controller extracts the matching identification from the adjustment signal and carries out matching verification of the matching identification with the preset equipment identification. The matching verification can be verification on whether the matching identification and the present equipment identification are consistent or not, and can also be verification on whether the matching identification and the preset equipment dentification belong to a corresponding pair of identifications.

Step S02, controlling the drive mechanism to move based on the adjustment signal after the matching verification is passed.

After the matching verification is passed, the controller controls the drive mechanism to move based on the adjustment signal, so that the position data of the drive mechanism and the corresponding adjusting member are synchronously corresponding to each other. For example, the drive mechanism is controlled according to angular position data of the adjustment signal to rotate to a corresponding angular position.

The control method of the lens driver according to the instant embodiment, upon receiving the adjustment signal wirelessly transmitted from the lens control device, first verify the matching identification of the adjustment signal with respect to the preset equipment identification, and controls the drive mechanism to move based on the adjustment signal only after the verification is passed. As such, even there is a signal from other wireless equipment in the communication channel between the lens control device and the lens driver, the lens driver will not mistakenly execute the wireless signal transmitted from other equipment, effectively preventing the communication signal between the lens control device and the lens driver from being interfered with and improving control accuracy of the lens.

Referring to FIG. 7, in the instant embodiment, the control method applicable to a lens driver further comprises:

Step S03, upon detecting a preset type of event, wirelessly transmitting a corresponding reminder signal to the lens control device, the reminder signal containing a preset equipment identification.

The preset type of event may comprise for example a low power level event and a drive mechanism being stalled event. When the power level is detected to be lower than a preset power level threshold (such as 15% of the maximum power level), a low power level reminder signal is wirelessly transmitted to the lens control device, and the low power level reminder signal contains a preset equipment identification; and when it is detected that the drive mechanism is stalled, a stalled reminder signal is wirelessly transmitted to the lens control device, and the stalled reminder signal contains a preset equipment identification. In this embodiment, the equipment identification is used for identification by the lens control device to determine which lens driver the signal comes from.

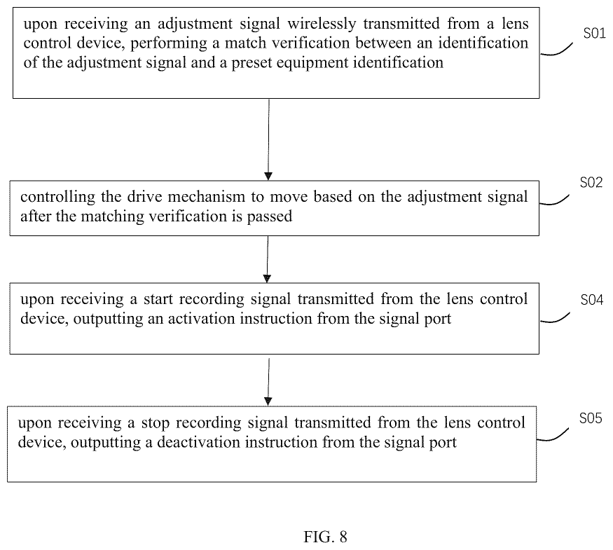

Referring to FIG. 8, in the instant embodiment, the lens driver comprises a signal port for connecting with the photographic equipment. The control method of the instant embodiment further comprises:

Step S04, upon receiving a start recording signal transmitted from the lens control device, outputting an activation instruction from the signal port; and

Step S05, upon receiving a stop recording signal transmitted from the lens control device, outputting a deactivation instruction from the signal port.

In the instant embodiment, the signal port of the lens driver is connected through the signal line to the photographic equipment (such as a camera). The controller, when receiving the start recording signal/the stop recording signal transmitted from the lens control device, outputs the activation instruction/the deactivation instruction from the corresponding signal port to the photographic equipment to control the photographic equipment to activate recording/deactivate recording. As such, the lens control device remotely controlling the recording function of the photographic equipment in a wireless manner is realized.

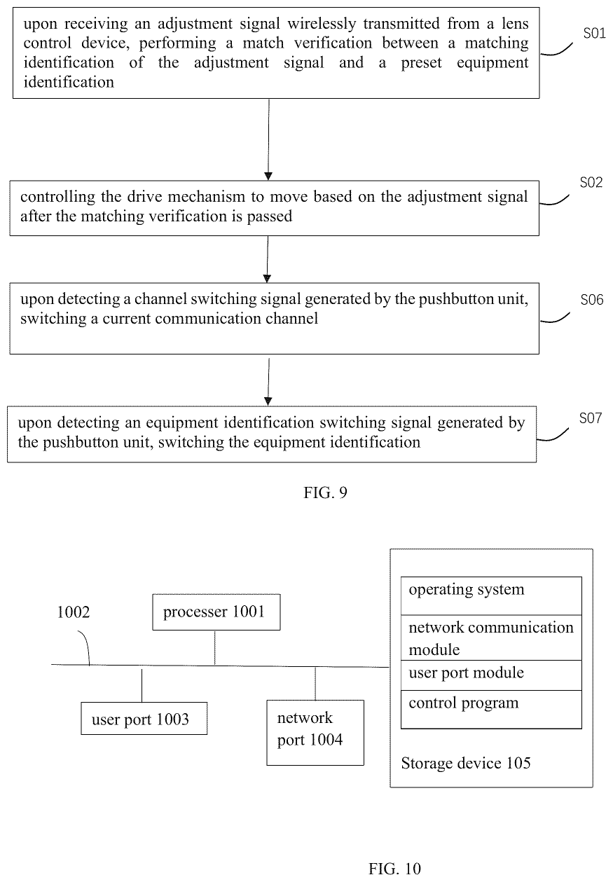

Referring to FIG. 9, in the instant embodiment, the lens driver further comprises a pushbutton unit. The control method further comprises:

Step S06, upon detecting a channel switching signal generated by the pushbutton unit, switching a current communication channel; and

Step S07, upon detecting an equipment identification switching signal generated by the pushbutton unit, switching the equipment identification.

In the instant embodiment, the controller controls the communication channel of the lens driver to switch in a preset manner according to the channel switching signal generated by the pushbutton unit. The preset manner can be a random manner or a sequentially increasing or decreasing manner. For example, the channel switching signal includes a channel plus 1 signal and a channel minus 1 signal. When a channel plus 1 signal is detected, a communication channel is switched by plus 1. When a channel minus 1 signal is detected, and a communication channel is switched by minus 1. In this embodiment, the communication channel may include 16 channels of F00-F15. The controller switches the equipment identification of the lens driver according to the identification switching signal generated by the pushbutton unit. For example, the equipment identification includes 01-03, and switching the equipment identification is switching sequentially and cyclically, and one identification switching signal makes switching one time (such as switching from 01 to 02, switching from 02 to 03, and switching from 03 to 01).

For example, the pushbutton unit comprises two pushbuttons, i.e., up and down pushbuttons. Single click or double click of the up pushbutton makes the communication channel plus 1, and single click or double click of the down pushbutton makes the communication channel minus 1; and long pressing of the up pushbutton enters an equipment identification switching mode, and single click of the up and down pushbuttons in the equipment identification switching mode respectively make the equipment identification plus 1 and minus 1.

The control method of the instant embodiment enables the lens driver to fulfill a channel switching function and an equipment identification switching function. The user can select any channel for communication according to the needs, and the user can also switch the equipment identification of each lens driver according to the needs in order to modify the corresponding relationship between the lens driver and the adjusting member.

Based on the control method applicable to a lens control device provided in the above-described embodiments, the present invention also provides a lens control device. The lens control device comprises at least one processor; and a storage device in communication connection with the at least one processor. The storage device is configured to store a computer program instruction which is executable by the at least one processor so as to have the at least one processor executing the control method applicable to a lens control device according to any one of the above-described embodiments.

Based on the control method applicable to a lens driver provided in the above-described embodiments, the present invention also provides a lens driver. The lens driver comprises at least one processor; and a storage device in communication connection with the at least one processor. The storage device is configured to store a computer program instruction which is executable by the at least one processor so as to have the at least one processor executing the control method applicable to a lens driver according to any one of the above-described embodiments.

Referring to FIG. 10 which is a schematic view illustrating electronic equipment of a hardware operation environment related to a solution of an embodiment of the present invention. The electronic equipment can be the lens control device of the present invention or the lens driver of the present invention.

As shown in FIG. 10, the electronic equipment may comprise: a processor 1001, such as a central processing unit (CPU), a network port 1004, a user port 1003, a storage device 1005, and a communication bus 1002. The communication bus 1002 is configured to fulfill connection and communication among the components. The user port 1003 may comprise a display screen and an input unit, such as a keyboard. Optionally, the user port 1003 may further comprise standard wired ports and wireless ports. The network port 1004 may optionally comprise standard wired ports and wireless ports (such as WI-FI port). The storage device 1005 may be a high-speed RAM storage device, and may also be a non-volatile memory, such as a disk storage device. The storage device 1005 may optionally be a storage device independent of the processor 1001.

Those skilled in the technical field can understand that the electronic equipment shown in FIG. 10 does not constitute a limitation to the electronic equipment and may comprise more or fewer components than what shown in the drawings, or a combination of some components, or an arrangement of different components.

As shown in FIG. 10, as a computer storge medium, the storage device 1005 may include an operating system, a network communication module, a user port module, and a control program.

In the electronic equipment shown in FIG. 10, the network port 1004 is mainly configured to connect to a backend server and to do data communication with the backend server; the user port 1003 is mainly configured to connect to a client end (user end) and to do data communication with the client end; and the processor 1001 can be configured to retrieve and execute the control program stored in the storage device 1005.

Based on the control method applicable to a lens control device and the control method applicable to a lens driver provided in the above-described embodiments, the present invention also provides a storage medium. The storage medium stores a computer program. The computer program, when executed by the processor, realizes the control method applicable to a lens control device and the control method applicable to a lens driver provided in the above-described embodiments. The control method applicable to a lens control device at least comprises the following steps:

Step 01, upon detecting a change of position data of one adjusting member, acquiring a current position data of the adjusting member and a matching identification corresponding to the adjusting member; and

Step 02, generating and wirelessly transmitting an adjustment signal based on the acquired position data and the matching identification, the adjustment signal containing the matching identification, the matching identification being provided for a lens driver that receives the adjustment signal to carry out matching verification; and
the control method applicable to a lens driver at least comprises the following steps:

Step 11, upon receiving the adjustment signal wirelessly transmitted from a lens control device, subjecting a matching identification of the adjustment signal to matching verification with a preset equipment identification; and

Step 12, when the matching verification is passed, controlling a drive mechanism to move based on the adjustment signal.

The present invention also provides a follow focus control system, which comprises the above-described lens control device and at least one above-described lens driver. The specific structures of the lens control device and the lens driver may refer to the above-described embodiments. The follow focus control system adopts all the technical solutions of all the embodiments of the above-described lens control device and the above-described lens driver, and therefore at least includes all the beneficial effects brought by the technical solutions of the above-described embodiments, and will not be described again one by one herein.

In some embodiments, the follow focus control system comprises multiple lens drivers, and when the equipment identifications of the multiple lens driver are identical, one adjustment signal of the lens control device is capable of controlling the multiple lens driver to drive synchronously. That is, one adjustment signal wirelessly transmitted from the lens control device is receivable by the multiple lens driver, and then, due to the equipment identifications being identical, the matching verification can pass for the matching identification of the adjustment signal in each of the lens drivers to control all the drive mechanism to move based on the adjustment signal. As such, usage scenarios that require synchronous drive control of multiple lens drivers can be satisfied.

In the several embodiments provided in the application, it should be understood that the disclosed methods and devices can be implemented in other ways. For example, the device embodiments described above are only illustrative. For example, the division of modules is only a logical function division. In actual implementation, there may be other division ways. For example, multiple modules or components may be combined or can be integrated into another device, or some features can be ignored, or not implemented. On the other hand, the coupling or direct coupling or communication connection between the shown or the discussed may be indirect coupling or communication connection through some ports, devices, or modules, and may be in electrical, mechanical or other forms.

The modules described as separate components may or may not be physically separated, and the components shown as modules may or may not be physical modules, that is, they may be located in one place, or they may be distributed to multiple network modules. Some or all of the modules can be selected according to actual needs to achieve the purpose of the solution of the instant embodiment.

In addition, each functional module in various embodiments of the present invention can be integrated into one processing module, or each module can exist physically alone, or two or more modules can be integrated into one module. The above integrated modules can be implemented in the form of hardware or software function modules.

If the integrated module is implemented in the form of a software function module and sold or used as an independent product, it can be stored in a computer-readable storage medium. Based on such an understanding, the technical solution of the present invention is essentially or contributes to the existing technology or all or part of the technical solution can be embodied in the form of a software product, and the computer software product is stored in a storage medium, including several instructions to cause a computer device (which can be a personal computer, a server, or a network device, and so on) to execute all or part of the steps of the method described in the various embodiments of the present invention. The aforementioned storage medium includes: USB storage, mobile hard disk, read-only memory (ROM), random access memory (RAM), magnetic disk or optical disk, and other media that can store program code.

What is described above is only part or preferred embodiments of the present invention. Neither the text nor the drawings can therefore limit the scope of protection of the present invention. Equivalent structure modifications that are made using the contents of the specification and the drawings of the present invention under the overall concept of the present invention are included in the scope of protection of the present invention.

1. A control method, applicable to a lens control device which comprises at least one adjusting member, the control method comprising:
upon detecting a change of position data of one of the at least one adjusting member, acquiring a current position data of said one of the at least one adjusting member and a matching identification corresponding to said one of the at least one adjusting member; and
generating and wirelessly transmitted an adjustment signal based on the current position data and the matching identification, wherein the adjustment signal contains the matching identification which is provided for a lens driver that receives the adjustment signal to perform a match verification.

2. The control method according to claim 1, wherein the lens control device comprises a digital signal port for wired connection to the lens driver, and after generating the adjustment signal the control method further comprises:
upon detecting the digital signal port being connected to the lens driver, switching to a wired signal transmission mode to perform signal transmission via the digital signal port; and
upon detecting the digital signal port not being connected to the lens driver, switching to a wireless signal transmission mode.

3. The control method according to claim 1, wherein the lens control device comprises a main body which is provided with one of the at least one of the adjusting member and at least one port for connecting with an external accessory including another adjusting member; and the control method further comprises:
upon detecting the main body connecting with the accessory, acquiring position data and a corresponding matching identification of the another adjusting member of the accessory; and
generating and wirelessly transmitting another adjustment signal based on the position data and the corresponding matching identification of the another adjusting member of the accessory, wherein the another adjustment signal contains the corresponding matching identification of the another adjusting member of the accessory which is provided for being received by the lens driver that receives the another adjustment signal to perform another match verification.

4. The control method according to claim 1, wherein the lens control device further comprises a display screen, and the control method further comprises:
controlling the display screen to display data information of the at least one adjusting member, the data information at least including the position data; and
wherein the lens control device comprises a main body, the main body being provided with one of at least one of the adjusting member and at least one port for connecting with an external accessory including another adjusting member; and the control method further comprises:
upon detecting the main body connecting with an accessory, adding a display zone on the display screen and displaying data information of the another adjusting member of the accessory in the display zone; and
upon detecting the main body disconnecting from the accessory, canceling the display zone from the display screen.

5. The control method according to claim 1, wherein the control method further comprises:
upon receiving a reminder signal transmitted from the lens driver, executing corresponding reminder processing according to the reminder signal.

6. The control method according to claim 1, wherein the lens control device further comprises a pushbutton device, and the control method further comprises a step of:
upon detecting a pushbutton signal of the pushbutton device, executing corresponding processing based on the pushbutton signal.

7. The control method according to claim 6, wherein the step of upon detecting a pushbutton signal of the pushbutton device, executing corresponding processing based on the pushbutton signal comprises:
upon detecting a channel switching signal, switching a current communication channel.

8. The control method according to claim 6, wherein the step of upon detecting a pushbutton signal of the pushbutton device, executing corresponding processing based on the pushbutton signal comprises:
upon detecting a first dot-mark setting signal, entering a dot-mark setting mode;
upon detecting a switching signal, switching a currently selected adjusting member in response to the switching signal;
upon detecting a second dot-mark setting signal, identifying mark A of the currently selected adjusting member;
upon detecting a third dot-mark setting signal, identifying mark B of the currently selected adjusting member; and
upon detecting a return signal, exiting the dot-mark setting mode.

9. The control method according to claim 6, wherein the step of upon detecting a pushbutton signal of the pushbutton device, executing corresponding processing based on the pushbutton signal comprises:
upon detecting a first dot-mark cancelling signal, entering a dot-mark cancelling mode;
upon detecting a switching signal, switching a currently selected adjusting member;
upon detecting a second dot-mark cancelling signal, cancelling mark A and mark B of the currently selected adjusting member; and
upon detecting a return signal, exiting the dot-mark cancelling mode.

10. The control method according to claim 6, wherein the step of upon detecting a pushbutton signal of the pushbutton device, executing corresponding processing based on the pushbutton signal comprises:
upon detecting an identification setting signal, entering an identification setting mode;
upon detecting a switching signal, switching a currently selected adjusting member;
upon detecting an up scrolling signal, up scrolling to switch the matching identification of the currently selected adjusting member;
upon detecting a down scrolling signal, down scrolling to switch the matching identification of the currently selected adjusting member; and
upon detecting a return signal, exiting the identification setting mode.

11. The control method according to claim 6, wherein the step of upon detecting a pushbutton signal of the pushbutton device, executing corresponding processing based on the pushbutton signal comprises:
upon detecting a stroke calibration signal, entering a stroke calibration mode;
upon detecting a switching signal, switching a currently selected adjusting member;
upon detecting a calibration confirmation signal, wirelessly transmitting a calibration instruction, wherein the calibration instruction contains the matching identification of the currently selected adjusting member; and
upon receiving a calibration completion signal or a calibration failure signal transmitted from the lens driver, or upon detecting a return signal, exiting the stroke calibration mode.

12. The control method according to claim 6, wherein the step of upon detecting a pushbutton signal of the pushbutton device, executing corresponding processing based on the pushbutton signal comprises:
upon detecting a locking signal, entering a pushbutton locking mode; and
upon detecting an unlocking signal, exiting the pushbutton locking mode; and/or
upon detecting a start recording signal, wirelessly transmitting a start recording instruction; and
upon detecting a stop recording signal, wirelessly transmitting a stop recording instruction.

13. A control method, applicable to a lens driver which comprises a drive mechanism for driving a lens, the control method comprising:
upon receiving an adjustment signal wirelessly transmitted from a lens control device, performing a match verification between an identification of the adjustment signal and a preset equipment identification; and
controlling the drive mechanism to move based on the adjustment signal after the matching verification is passed.

14. The control method according to claim 13, wherein the control method further comprises:
upon detecting a preset type of event, wirelessly transmitting a corresponding reminder signal to the lens control device, wherein the reminder signal contains a preset equipment identification.

15. The control method according to claim 13, wherein the lens driver comprises a signal port for connecting with photographic equipment, and the control method further comprises:
upon receiving a start recording signal transmitted from the lens control device, outputting an activation instruction from the signal port; and
upon receiving a stop recording signal transmitted from the lens control device, outputting a deactivation instruction from the signal port.

16. The control method according to claim 13, wherein the lens driver further comprises a pushbutton unit, and the control method further comprises:
upon detecting a channel switching signal generated by the pushbutton unit, switching a current communication channel; and/or
upon detecting an equipment identification switching signal generated by the pushbutton unit, switching the equipment identification.

17. A lens control device, comprising at least one adjusting member, a storage device, a processor, and a control program stored in the storage device and executable in the processor, the control program implementing steps of the control method according to claim 1 when executed in the processor.

18. A lens driver, comprising a drive mechanism, a storage device, a processor, and a control program stored in the storage device and executable in the processor, the control program implementing steps of the control method according to claim 13 when executed in the processor.

19. A follow focus control system, comprising the lens control device according to claim 17 and at least one lens driver which comprise a drive mechanism, a storage device, a processor, and a control program stored in the storage device and executable by the processor to perform a control method comprising:
upon receiving the adjustment signal wirelessly transmitted from the lens control device, performing a match verification between the identification of the adjustment signal and a preset equipment identification; and
controlling the drive mechanism to move based on the adjustment signal after the match verification is passed.

20. The follow focus control system according to claim 19, comprising multiple lens drivers, wherein when the equipment identifications of the multiple lens drivers are identical, one adjustment signal of the lens control device controls the multiple lens drivers to drive synchronously.
